(19) United States
(12) Patent Application Publication
(10) Pub. No.: US 2012/0065341 A1
(43) Pub. Date: Mar. 15, 2012

(54) SILICON DIOXIDE DISPERSIONS

(75) Inventors: Berend Eling, Lemfoerde (DE); Marine Boudou, Mannheim (DE); Stefan Auffarth, Westerkappeln (DE); Oliver Reese, Lemfoerde (DE)

(73) Assignee: BASF SE, Ludwigshafen (DE)

(21) Appl. No.: 13/229,005

(22) Filed: Sep. 9, 2011

Related U.S. Application Data
(60) Provisional application No. 61/381,496, filed on Sep. 10, 2010.

(51) Int. Cl. C08L 75/04; C08G 71/04; C08L 77/00; C09K 3/00

(52) U.S. Cl. 525/424; 252/183.13; 528/26; 525/450

(57) ABSTRACT

The invention relates to stable silicon dioxide dispersions and also their use for producing polyurethanes. The silicon dioxide dispersions are largely or preferably completely free of water and comprise silicon dioxide particles having an average diameter of 1-150 nm and at least one chain extender. The silicon dioxide particles can be modified by means of a silane (S) which comprises groups which are reactive toward isocyanates. Furthermore, a polyol, in particular a polyesterol and/or an isocyanate-comprising compound can be comprised in the silicon dioxide dispersions.

This patent application claims the benefit of pending U.S. provisional patent application Ser. No. 61/381,496 filed on Sep. 10, 2010, incorporated in its entirety herein by reference.

The invention relates to stable silicon dioxide dispersions and also their use for producing polyurethanes. The silicon dioxide dispersions are largely or preferably completely free of water and comprise silicon dioxide particles having an average diameter of 1-150 nm and at least one chain extender. The silicon dioxide particles can be modified by means of a silane (S) which comprises groups which are reactive toward isocyanates. Furthermore, a polyol, in particular a polyesterol and/or an isocyanate-comprising compound can be comprised in the silicon dioxide dispersions.

The European patent application PCT/EP 2010/053106 relates to a process for producing silica-comprising dispersions comprising polyetherols or polyetheramines and their use for producing polyurethane materials. In this process, the silica-comprising dispersions are produced by first admixing an aqueous silica sol with polyetherol and/or polyetheramine. The water is then at least partly distilled off, after which the silicon dioxide particles comprised in the dispersion are admixed with a silane which has, for example, alkyl or cycloalkyl substituents which are optionally provided with groups which are reactive toward an alcohol, an amine or an isocyanate. The polyetherol-comprising silicon dioxide dispersions can be used for producing polyurethane materials if an organic isocyanate is additionally present. In one embodiment, polyesterols are used as possible constituents of polyisocyanate prepolymers which can in turn be reacted with a polyol to give polyurethane.

WO 2010/043530 relates to a process for producing silica-comprising polyol dispersions and their use for producing polyurethane materials. The silica-comprising polyols are produced by admixing aqueous silica sol having an average particle diameter of 1-150 nm with at least one organic solvent such as methanol, cyclohexanol or acetone. A polyol is added to this mixture, after which the organic solvent and water are at least partly distilled off. The mixture is subsequently admixed with at least one silane, as a result of which the silicon dioxide particles are surface-modified. If an organic polyisocyanate is additionally comprised in the silica-comprising polyol, these mixtures can be used for producing polyurethane materials. Polyols used are, in particular, polyether polyols. Polyesterols, on the other hand, are used only as constituent of polyisocyanate prepolymers.

It is an object of the invention to produce stable dispersions of silicon dioxide particles having a diameter of the particles of <150 nm. A further object is to produce polyurethanes having improved properties using the stable silicon dioxide dispersions of the invention.

The object is achieved by silicon dioxide dispersions which can be produced by a process comprising the following steps:
a) admixing of an aqueous silica sol (K) having an average particle diameter of from 1 to 150 nm, a content of silicon dioxide of from 1 to 60% by weight and a pH of from 1 to 6 with at least one chain extender to give a mixture (A) of aqueous silica sol and chain extender,
b) removal of the water from the mixture (A) obtained in step (a).

The silicon dioxide dispersions of the invention have the advantage that they are very stable and/or are present as transparent dispersions. The silicon dioxide dispersions of the invention can be particularly advantageously combined with polyols, in particular polyesterols, by which means polyurethanes (PUs) having improved properties can be produced because of the stable polyol- or polyesterol-comprising dispersions formed. The polyurethanes produced in this way display, for example, an improvement in the Vicat softening temperature, the stress values at various elongations or a significant lowering of the compression set and/or the abrasion. Branching can be produced in the polyurethanes by means of the silicon dioxide dispersions of the invention in a relatively simple and inexpensive way.

Although the silicon dioxide dispersions of the invention can be used very widely, their use for producing, first and foremost, elastomeric polyurethanes, in particular thermoplastic polyurethane (TPU), microcellular elastomers, casting elastomers, RIM elastomers, spray elastomers, elastomeric coatings and “millable gums” is preferred. The hardnesses which can be achieved for polyurethane elastomers can vary from 10 Shore A to more than 75 Shore D. In addition, the chemical crosslinking, i.e. the crosslinking which can be obtained by incorporation of monomeric building blocks having a functionality of greater than 2, is low for such materials. TPU has, for example, a virtually linear structure, which is also necessary for processing this material in an injection molding process. Thus, it is found, advantageously, in these materials that the addition of the silicon dioxide dispersions of the invention brings about further improvements in the mechanical properties, in particular the mechanical properties at elevated temperature. Without wishing to be tied to a theory, it is assumed that the silicate particles admixed with NCO-reactive groups bring about branching in the polyurethane. The branching or crosslinking due to incorporation of the NCO-reactive silicon dioxide particles in the polyurethane has a particularly positive effect on the mechanical properties of the polyurethane, for example an increase in the softening temperature, improvement of the compressive deformation and/or improvement of the abrasion.

The invention is described in more detail below.

In step (a), the silicon dioxide dispersions of the invention are produced by admixing an aqueous silica sol (K) having an average particle diameter of from 1 to 150 nm, a content of silicon dioxide of from 1 to 60% by weight and a pH of from 1 to 6 with at least one chain extender to give a mixture (A) of aqueous silica sol and chain extender.

Aqueous silica sol (K) as such, which comprises silicon dioxide particles, is known in principle to those skilled in the art. The aqueous solutions (K) of polysilicic acid particles (silica sol) used comprise particles having an average particle diameter of from 1 to 150 nm, preferably from 2 to 120 nm, particularly preferably from 3 to 100 nm, very particularly preferably from 4 to 80 nm, in particular from 5 to 50 nm and especially from 8 to 40 nm.

The content of silicon dioxide or silicic acid (calculated as SiO₂) is from 1 to 60% by weight, preferably from 5 to 55% by weight, particularly preferably from 10 to 40% by weight. Silica sols having a lower content can also be used, but the additional content of water then has to be additionally separated by distillation in the later step b).

The aqueous solutions (K) are preferably colloidal solutions of polysilicic acid which may optionally be stabilized to a small extent by means of alkali metal, alkaline earth metal, ammonium, aluminum, iron(II), iron(III) and/or zirconium ions, preferably alkali metal, alkaline earth metal, ammonium and/or iron(III) ions, particularly preferably alkali metal, alkaline earth metal and/or ammonium ions, very particularly preferably alkali metal and/or alkaline earth metal ions and in particular alkali metal ions.

Among alkali metal ions, preference is given to sodium and/or potassium ions, with sodium ions being particularly preferred.

Among alkaline earth metal ions, preference is given to magnesium, calcium and/or beryllium ions, with particular preference being given to magnesium and/or calcium ions, very particularly preferably magnesium ions.

The molar ratio of metal ions to silicon atoms in (K) is from 0:1 to 0.1:1, preferably 0.002-0.04:1.

After adjustment of the pH, the silica sol (K) used has a pH of the aqueous phase of from 1 to 6, preferably from 2 to 4.

In the present text, an aqueous colloidal solution is a solution of optionally stabilized silica particles which have an average particle diameter in the range from 1 to 150 nm and do not settle even after storage at 20° C. for a period of one month.

In the present text, a sol is a colloidally disperse, incoherent (i.e. each particle can move freely) solution of a solid in water, here as silica sol a colloidally disperse solution of silicon dioxide in water.

The acidic aqueous silica sols (K) used according to the invention can, for example, be obtained in three different ways:
by acidification of the corresponding alkaline silica sols,
by production from low molecular weight silicic acids, preferably water glass, i.e. salt-like particles having a diameter of less than 1 nm, or
by condensation of esters of low molecular weight silicic acids.

The aqueous solutions of alkaline silica sols generally have a pH of from 8 to 12, preferably from 8 to 11. These alkaline silica sols are commercially available and are thus a readily available and preferred starting material for the process of the invention.

The production of the silica sols (K) to be used according to the invention from these alkaline silica sols is carried out by setting the desired pH in these silica sols, for example by adding mineral acids or admixing the alkaline silica sols with an ion exchanger. Preference is given to adjusting the pH by means of ion exchangers, particularly when the silica sol is admixed with a polyetheramine.

The acidification can be carried out using any acids, preferably by means of hydrochloric acid, nitric acid, phosphoric acid, sulfuric acid, acetic acid, formic acid, methylsulfonic acid, para-toluenesulfonic acid, or else by admixing with an acidic ion exchanger, preferably by acidification using hydrochloric acid, nitric acid, phosphoric acid, sulfuric acid or acetic acid, particularly preferably using hydrochloric acid, nitric acid or sulfuric acid and very particularly preferably by acidification with sulfuric acid.

In a preferred embodiment, the silica sols (K) are produced by admixing alkaline silica sols with an ion exchanger. This has the result that the electrolyte content in the silica sols (K) is low, for example less than 0.2% by weight and preferably less than 0.1% by weight.

For the present purposes, electrolytes are inorganic ionic constituents other than silicates, hydroxides and protons. These electrolytes, which originate predominantly from the stabilization of the alkaline silica sols, are added to stabilize the particles after the suspension has been produced.

It is also conceivable to produce the silica sols (K) from water glass by acidification, for example with an ion exchanger or by admixing with mineral acid. As water glass, preference is given to using potassium silicate and/or sodium silicate which particularly preferably has a ratio of from 1 to 10 mol of SiO₂ to 1 mol of alkali metal oxide, very particularly preferably from 1.5 to 6 and in particular from 2 to 4 mol of SiO₂ to 1 mol of alkali metal oxide.

In this case, the reaction mixture is allowed to react until a silica sol (K) having the desired size has been formed, and the process of the invention is then carried out.

The low molecular weight silicic acids (orthosilicic and oligosilicic acid) are normally stable only in highly dilute aqueous solutions having a content of a few % by weight and are therefore generally concentrated before further use.

Furthermore, the silica sols (K) can be produced by condensation of esters of low molecular weight silicic acids. These are usually C₁-C₄-alkyl esters, in particular ethyl esters, of oligosilicic and in particular orthosilicic acids which form silica sols (K) in acidic or basic medium.

In step (a), the aqueous acidic silica sol is admixed with (at least one) chain extender in an amount corresponding to from 0.001 to 100 times the amount of the silica sol used, preferably from 0.01 to 50 times the amount, particularly preferably from 0.05 to 30 times the amount.

A chain extender as such is known in principle to those skilled in the art. According to the invention, preference is given to using one chain extender, but mixtures of two or more chain extenders can optionally also be used.

As chain extenders, preference is given to using compounds having a molecular weight of less than 600 g/mol, for example compounds having 2 hydrogen atoms which are reactive toward isocyanates. These can be used individually or else in the form of mixtures. Preference is given to using diols having molecular weights of less than 300 g/mol. Possible compounds of this type are, for example, aliphatic, cycloaliphatic and/or araliphatic diols having from 2 to 14, preferably from 2 to 10, carbon atoms, in particular alkylene glycols. Suitable compounds are thus also low molecular weight hydroxyl-comprising polyalkylene oxides based on ethylene oxide and/or 1,2-propylene oxide. Preferred chain extenders are (mono)ethylene glycol, 1,2-propanediol, 1,3-propanediol, pentanediol, tripropylene glycol, 1,10-decanediol, 1,2-, 1,3-, 1,4-dihydroxycyclohexane, diethylene glycol, triethylene glycol, dipropylene glycol, 1,4-butanediol, 1,6-hexanediol, 2-methylpropane-1,3-diol, 2,2-dimethylpropane-1,3-diol, bisphenol A bis(hydroxyether), ethanolamine, N-phenyldiethanolamine, phenylenediamine, diethyltoluenediamine, polyetheramines and bis(2-hydroxyethyl)-hydroquinone. Particularly preferred chain extenders are monoethylene glycol, diethylene glycol, 2-methyl-1,3-propanediol, 1,4-butanediol, 1,5-pentanediol, 1,6-hexanediol or mixtures thereof, with very particular preference being given to 1,4-butanediol or monoethylene glycol.

Admixing of the above-described aqueous silica sol (K) with at least one chain extender gives, according to the invention, the mixture (A). The mixture (A) thus comprises the aqueous silica sol and the chain extender. The mixture (A) can optionally also comprise further components such as organic solvents or additives. In one embodiment of the present invention, the mixture (A) comprises no further components in addition to the aqueous silica sol and the chain extender; the mixture (A) preferably consists essentially of aqueous silica sol and chain extender.

In step (b), water is removed, preferably distilled off, from the mixture (A) obtained in step (a). After removal of the water, a silicon dioxide dispersion comprising the chain extender in addition to the silicon dioxide particles is still present.

The removal, preferably distillation, of water is carried out under atmospheric pressure or reduced pressure, preferably at from 1 to 800 mbar, particularly preferably from 5 to 100 mbar. Instead of distillation, the water can also be removed by absorption, pervaporation or diffusion through membranes.

The temperature at which the distillation is carried out depends on the boiling point of water at the respective pressure. The temperature is preferably not more than 140° C., particularly preferably not more than 100° C.

The distillation can be carried out batchwise, semicontinuously or continuously.

For example, it can be carried out batchwise from a stirred vessel which can optionally be superposed by a short rectification column.

The introduction of heat into the stirred vessel is effected via internal and/or external heat exchangers of a conventional type and/or double-walled heating, preferably external circulation vaporizers having natural or forced convection. Mixing of the reaction mixture is carried out in a known manner, e.g. by stirring, pumped circulation or natural convection.

When carried out continuously, the distillation is preferably carried out by passing the material to be distilled through a falling film evaporator or a heat exchanger.

Suitable distillation apparatuses for this purpose are all distillation apparatuses known to those skilled in the art, e.g. circulation vaporizers, thin film evaporators, falling film evaporators, wiped film evaporators, optionally each with superposed rectification columns, and also stripping columns. Suitable heat exchangers are, for example, Robert evaporators or shell-and-tube or plate heat exchangers.

The water comprised in the mixture (A) is preferably removed completely, in particular completely distilled off. The content of silicon dioxide (silicates) in the resulting dispersion is generally from 5 to 60% by weight, preferably from 5 to 50% by weight and particularly preferably from 10 to 40% by weight. The removal of the water is preferably carried out so that the chain extender remains completely or virtually completely in the silicon dioxide dispersion of the invention.

The residual water content in the dispersion should be less than 5% by weight, preferably less than 3% by weight, particularly preferably less than 2% by weight, very particularly preferably less than 1% by weight, in particular less than 0.5% by weight and especially less than 0.3% by weight. The amounts for the residual water content are based on the silicon dioxide dispersion, i.e. the amount of silicon dioxide particles and chain extender.

The water is preferably removed, in particular distilled off, in step (b) at a temperature which is increased stepwise in the range from 30° C. to 75° C. In particular, the water is removed under reduced pressure and at a temperature which is increased stepwise from 30° C. to 75° C. over a period of 6 hours, with the temperature being 75° C. over the last 1-2 hours.

The silicon dioxide comprised in the silicon dioxide dispersions of the invention is preferably modified by means of at least one silane (S) which comprises a group which is reactive toward isocyanates.

The modification by means of the silane (S) occurs on the surface of the (respective) silicon dioxide particles comprised in the silicon dioxide dispersions of the invention. Methods for surface modification (also referred to as silanization) as such are known to those skilled in the art. According to the invention, the (surface) modification of the respective silicon dioxide particles is carried out after the water has been removed from the mixture (A). One or more additional steps can optionally be carried out between removal of the water from the mixture (A) and modification by means of the silane (S).

The silane (S) comprises a group which is reactive toward isocyanates. The silane (S) can optionally also comprise two or more groups which are reactive toward isocyanates, but preferably comprises one group which is reactive toward isocyanates.

According to the invention, this group is still reactive toward isocyanates even after modification of the surface of the silicon dioxide particles by means of the silane (S). In other words, this means that the modified silicon dioxide particles after the modification of the surface of the silicon dioxide particles by means of the silane (S) have a group which is reactive toward isocyanates. The group which is reactive toward isocyanates is optionally provided with a protective group by methods known to those skilled in the art during the modification of the surface of the silicon dioxide particles. Silicon dioxide dispersions comprising i) at least one chain extender and ii) silicon dioxide which has been modified by means of at least one silane (S) comprising a group which is reactive toward isocyanates are thus also provided by the present invention.

Suitable silanes (S) as such and/or groups which are reactive toward isocyanates are known to those skilled in the art. A preferred group which is reactive toward isocyanates is an amino group or a hydroxyl group. The silane (S) therefore preferably has at least one hydroxyl-comprising substituent and/or at least one amino-comprising substituent. Furthermore, a thiol group or an epoxy group can also be used as group which is reactive toward isocyanates.

The silane (S) preferably additionally has at least one silyl group which is at least monoalkoxylated. The silane (S) can optionally also comprise two or more silyl groups which are in turn each at least monoalkoxylated. Preference is given to a silane (S) which has precisely one at least monoalkoxylated silyl group, for example a monoalkoxylated to trialkoxylated, preferably from dialkoxylated to trialkoxylated, particularly preferably trialkoxylated silyl group.

In addition, the silane (S) can have at least one alkyl, cycloalkyl and/or aryl substituent (radical), where these substituents can optionally have further heteroatoms such as O, S or N. In the silane (S), the alkyl, cycloalkyl and/or aryl radicals and the groups which are reactive toward isocyanates are preferably combined in one substituent. Such a substituent has, for example, an alkyl fragment which is in turn substituted by an amino group or a hydroxyl group. The groups which are reactive toward isocyanates are thus joined to the silyl groups by alkylene, cycloalkylene or aryl groups, preferably alkylene groups, preferably having from 1 to 20 carbon atoms, as spacer groups. However, alkyl, cycloalkyl and/or aryl radicals which are not substituted by a group which is reactive toward isocyanates can also be comprised in the silanes (S).

Examples of alkylene groups are methylene, 1,2-ethylene (—CH₂—CH₂—), 1,2-propylene (—CH(CH₃)—CH₂—) and/or 1,3-propylene (—CH₂—CH₂—CH₂—), 1,2-, 1,3- and/or 1,4-butylene, 1,1-dimethyl-1,2-ethylene, 1,2-dimethyl-1,2-ethylene, 1,6-hexylene, 1,8-octylene or 1,10-decylene, preferably methylene, 1,2-ethylene, 1,2- or 1,3-propylene, 1,2-, 1,3- or 1,4-butylene, particularly preferably methylene, 1,2-ethylene, 1,2- and/or 1,3-propylene and/or 1,4-butylene and very particularly preferably methylene, 1,2-ethylene, 1,2- and/or 1,3-propylene.

Further suitable silanes of this type are trialkoxysilanes which are substituted by an epoxyalkyl group, in particular by a glycidoxypropyl group (—CH₂—CH₂—CH₂—O—CH₂—CH(O)CH₂). The epoxy group can react with amino groups, for example of monofunctional polyetheramines, or hydroxyl-comprising components, for example hyperbranched polyols.

The silanes (S) can optionally also have further heteroatoms: examples are 2-[methoxy(polyethylenoxy)propyl]trimethoxysilane, 3-methoxypropyltrimethoxysilane, bromophenyltrimethoxysilane, 3-bromopropyltrimethoxysilane, 2-chloroethylmethyl-dimethoxysilane, (heptadecafluoro-1,1,2,2-tetrahydrodecyl)triethoxysilane, (heptadecafluoro-1,1,2,2-tetrahydrodecyl)trimethoxysilane, diethylphosphatoethyltriethoxysilane, 2-(diphenylphosphino)ethyltriethoxysilane, 3-(N,N-dimethylaminopropyl)trimethoxysilane, 3-methoxypropyltrimethoxysilane, 3-(methacryloxy)propyltrimethoxysilane, 3-acryloxypropyltrimethoxysilane, 3-(methacryloxy)propyltriethoxysilane or 3-(methacryloxy)propyl methyldimethoxysilane.

More preferred silanes (S) are 2-(3,4-epoxycyclohexyl)ethyltriethoxysilane, 2-(3,4-epoxycyclohexyl)ethyltrimethoxysilane, 3-aminopropylmethyldimethoxysilane, 3-aminopropyldimethylmethoxysilane, 3-aminopropyldimethylethoxysilane, N-(2′-aminoethyl)-3-aminopropylmethyldimethoxysilane, N-(2′-aminoethyl)-3-aminopropylmethyldiethoxysilane, N-(2′-aminoethyl)-3-aminopropylmethoxysilane, N-(2′-aminoethyl)-3-aminopropylethoxysilane, 3-mercapto propyltrimethoxysilane, 3-mercaptopropyltriethoxysilane, 4-aminobutyltriethoxysilane, 1-amino-2-(dimethylethoxysilyl)propane, (aminoethylaminoethyl)phenethyltrimethoxysilane, N-(2-aminoethyl)-3-aminopropyltriethoxysilane, p-aminophenyltrimethoxysilane, 3-aminopropylmethyldiethoxysilane, 3-aminopropyltriethoxysilane, 3-aminopropyltrimethoxysilane, 11-aminoundecyltriethoxysilane, (3-glycidoxypropyl)trimethoxysilane, (3-glycidoxypropyl)triethoxysilane, N-(hydroxyethyl)-N-methylaminopropyltrimethoxysilane, hydroxymethyltriethoxysilane, 3-mercaptopropylmethyldimethoxysilane, 3-mercaptopropylmethyldiethoxysilane, N-methylaminopropylmethyldimethoxysilane or bis(2-hydroxyethyl)-3-aminopropyltriethoxysilane.

Even more preferred silanes (S) are trialkoxysilanes substituted by the following groups:
CH₂—CH₂—CH₂—NH₂
CH₂—CH₂—CH₂—SH
CH₂—CH₂—CH₂—NH—CH₂—CH₂—CH₂—NH₂
CH₂—CH₂—CH₂—N(CH₂—CH₂OH)₂

The abovementioned groups react particularly well with isocyanate groups and thus produce a stable covalent bond between the silicon dioxide particles and the PU matrix.

Particularly preferred silanes (S) are 3-aminopropylmethyldimethoxysilane, 3-aminopropyldimethylmethoxysilane, 3-aminopropyldimethylethoxysilane, N-(2′-aminoethyl)-3-aminopropylmethyldimethoxysilane, N-(2′-aminoethyl)-3-aminopropylmethyldiethoxysilane, N-(2′-aminoethyl)-3-aminopropylmethoxysilane, N-(2′-aminoethyl)-3-aminopropylethoxysilane, 4-aminobutyltriethoxysilane, N-(2-aminoethyl)-3-aminopropyltriethoxysilane, p-aminophenyltrimethoxysilane, 3-aminopropylmethyldiethoxysilane, 3-aminopropyltriethoxysilane, 3-aminopropyltrimethoxysilane, 11-aminoundecyltriethoxysilane, N-(hydroxyethyl)-N-methylaminopropyltrimethoxysilane, hydroxymethyltriethoxysilane or bis(2-hydroxyethyl)-3-aminopropyltriethoxysilane.

The silane (S) thus preferably has an at least monoalkoxylated silyl group, a hydroxyl-comprising substituent, an amino-comprising substituent and/or an alkyl, cycloalkyl or aryl substituent.

For the purposes of the present invention, alkoxylated silyl groups are groups
(R¹—O—)ₙ—Si—
in which

R¹ is C₁-C₂₀-alkyl, preferably C₁-C₄-alkyl, and
n is an integer from 1 to 3, preferably from 2 to 3 and particularly preferably 3.

Examples of C₁-C₂₀-alkyl are methyl, ethyl, isopropyl, n-propyl, n-butyl, isobutyl, sec-butyl, tert-butyl, n-hexyl, n-heptyl, n-octyl, 2-ethylhexyl, n-decyl, n-dodecyl, n-tetradecyl, n-hexadecyl, n-octadecyl and n-eicosyl.

Examples of C₁-C₄-alkyl are methyl, ethyl, isopropyl, n-propyl, n-butyl, isobutyl, sec-butyl and tert-butyl.

Preferred radicals R¹ are methyl, ethyl, n-butyl and tert-butyl, particularly preferably methyl and ethyl.

In a further embodiment of the present invention it is preferred to employ a silane (S), which is produced by reacting i) a trialkoxysilane substituted by an epoxyalkyl group and ii) a polyetheramine. Optionally, mixtures of 2 or more compounds i) and/or ii) may also be employed. Additionally, it is also possible to react compound ii) with compound i) after the silicon dioxide contained within the dispersion was modified by compound i).

Compound i) is preferably a glycidoxyalkyltrialkoxysilane, wherein alkyl is methyl, ethyl or propyl and alkoxy is methoxy or ethoxy, compound i) is in particular 3-glycidoxypropyltrimethoxysilane. The compound ii) is preferably mono-, bi- or trifunctional polyetheramine with a molecular weight of 300 to 5000, wherein the functionality is related to the number of amino groups contained therein. Such polyether amines are commercially available, preferably under the term “Jeffamine” from the Huntsman-group. Monofunctional polyetheramines are more preferred compared to bifunctional polyetheramines, which in turn are preferred compared to trifunctional polyetheramines. Most preferably, compound ii) is a monofunctional polyetheramine with a molecular weight of 500 to 2500. An example for this is the commercially available Jeffamine® M-2070 of company Huntsman Performance Chemicals, Eversberg, Belgium.

The silane (S) can optionally also be used in mixtures with at least one (further) silane (S2), where the silane (S2) does not have any groups which are reactive toward isocyanates. In this context, no groups which are reactive toward isocyanates means that no or only minor amounts of isocyanate-reactive groups (for example incompletely reacted alkoxy substituents) originating from the silane (S2) are comprised on the modified silicon dioxide particles after modification of the surface of the silicon dioxide particles by the silane (S2). The isocyanate-reactive groups comprised on the modified silicon dioxide particles, on the other hand, come from the silane (S).

Preferred silanes (S2) are methyltrimethoxysilane, n-propyltriethoxysilane, dimethyldimethoxysilane, phenyltrimethoxysilane, n-octyltriethoxysilane, isobutyltriethoxysilane, n-butyltrimethoxysilane, t-butyltrimethoxysilane, methyltriethoxysilane, benzyltriethoxysilane, trimethylmethoxysilane, vinyltrimethoxysilane, vinyltriethoxysilane, allyltrimethoxysilane, allyltriethoxysilane, butenyltriethoxysilane, n-decyltriethoxysilane, di-n-butyldimethoxysilane, diisopropyldimethoxysilane, dimethyldiethoxysilane, dodecylmethyldiethoxysilane, dodecyltriethoxysilane, ethyltrimethoxysilane, ethyltriethoxysilane, hexadecyltriethoxysilane, hexadecyltrimethoxysilane, hexyltrimethoxysilane, hexyltriethoxysilane, isobutylmethyltriethoxysilane, isobutyltrimethoxysilane, n-octadecyltriethoxysilane, n-octadecyltrimethoxysilane, n-octadecylmethyldimethoxysilane, n-octadecylmethyldiethoxysilane, n-octylmethyldiethoxyslane, octyldimethylmethoxysilane, pentyltriethoxysilane, phenyl methyldimethoxysilane and phenyltriethoxysilane.

The reaction with the silane (S) and, if used, the silane (S2) modifies the surface of the respective silica sol (K) so as to improve the compatibility between the originally polar silica sol and a polyol, in particular a polyesterol. Particular effects can be achieved in a targeted manner by combination of the various silanes, e.g. combination of reactive and unreactive silanes. It is also possible to use mixtures of differently modified silicon dioxide particles.

In general, the silane (S) (and the silane (S2)) is used in an amount of from 0.1 to 20 μmol per m² of surface area of (K).

This generally corresponds to an amount of from 0.01 to 5 mmol of (S) per gram of (K), preferably from 0.05 to 4 mmol of (S) per gram of (K) and particularly preferably from 0.1 to 3 mmol of (S) per gram of (K).

The reaction with (S) is carried out with stirring at a temperature of from 10 to 100° C., preferably from 20 to 90° C., particularly preferably from 30 to 80° C.

Under these reaction conditions, the mixture is allowed to react for from 1 to 48 hours, preferably from 3 to 36 hours, particularly preferably from 4 to 24 hours.

The silane (S) is added in amounts of from 0.1 to 30 mol %, preferably from 0.3 to 25 mol % and particularly preferably from 0.5 to 20 mol %, based on the SiO₂ content.

Subsequent to the modification of the surface of the silicon dioxide particles by means of the silane (S), the pH of the silicon dioxide dispersion of the invention may, in an optional step, be adjusted to a value of from 7 to 12, This is effected by addition of a basic compound. Suitable basic compounds are, in particular, strongly basic compounds such as alkali metal hydroxides (NaOH, KOH, LiOH) and alkali metal alkoxides. The addition of the basic compound enables the reactivity of a polyol component which is likewise present to be increased. This is attributed to acidic silanol groups on the surface of the silica particles being able to adsorb the amine catalyst, as a result of which the reactivity of a polyurethane system is reduced. This can be countered by addition of a basic compound. This optional step of adjusting the pH to a value of from 7 to 12 is preferably not carried out for the silicon dioxide dispersion of the invention.

Preference is given to adding at least one polyol to the silicon dioxide dispersion of the invention comprising silicon dioxide which has been modified by means of at least one silane (S). Polyols as such are known to those skilled in the art, for example polyetherols, polyesterols or polycarbonate polyols. The polyol is preferably a polyetherol and/or a polyesterol, in particular at least one polyesterol. The present invention therefore further provides silicon dioxide dispersions comprising i) at least one chain extender, ii) silicon dioxide which has been modified by means of at least one silane (S) comprising a group which is reactive toward isocyanates and iii) at least one polyol, in particular at least one polyesterol.

Suitable polyetherols have a number average molecular weight of from 62 to 10 000 g/mol. They are based on propylene oxide, ethylene oxide or propylene oxide and ethylene oxide

Suitable polyetherols are prepared from a starter molecule comprising from 2 to 6 reactive hydrogen atoms in bound form by polymerization of ethylene oxide and/or propylene oxide by known methods. The polymerization can be carried out as an anionic polymerization using alkali metal hydroxides or alkali metal alkoxides as catalysts or as a cationic polymerization using Lewis acids such as antimony pentachloride or boron fluoride etherate. Furthermore, multimetal cyanide compounds, known as DMC catalysts, can also be used as catalysts. It is also possible to use tertiary amines, e.g. triethylamine, tributylamines, trimethylamines, dimethylethanolamine or dimethylcyclohexylamine, as catalyst. Ethylene oxide and propylene oxide can be polymerized in pure form, alternately in succession or as mixtures.

Suitable starter molecules having from 2 to 6 reactive hydrogen atoms are, for example, water and dihydric or trihydric alcohols such as ethylene glycol, 1,2- and 1,3-propanediol, diethylene glycol, dipropylene glycol, 1,4-butanediol, glycerol, trimethylolpropane, also pentaerythritol, sorbitol and sucrose. Further suitable starter molecules are amine starters such as triethanolamines, diethanolamines, ethylenediamines and toluenediamines.

The polyetherols preferably have an OH number in the range from 10 to 1825.

Particularly preferred polyetherols are prepared from dihydric or trihydric alcohols, in particular ethylene glycol, trimethylolpropane or glycerol, and are ethylene oxide homopolymers, propylene oxide homopolymers or ethylene oxide-propylene oxide copolymers. A further class of preferred polyetherols are alpha-hydro-omega-hydroxypoly(oxy-1,4-butanediyls), which are also known as PTHF. These particularly preferred polyetherols have a molecular weight of from 62 to 10 000 g/mol and an OH number of from 10 to 1825, preferably from 15 to 500, more preferably from 20 to 100.

Suitable polyesterols are known to those skilled in the art. It is possible to use, for example, polyesterols such as polycaprolactam or polyesterols prepared by condensation of at least one polyfunctional alcohol, preferably at least one diol, having from 2 to 12 carbon atoms, preferably from 2 to 6 carbon atoms, with polyfunctional carboxylic acids having 2 to 12 carbon atoms, for example succinic acid, glutaric acid, adipic acid, suberic acid, azelaic acid, sebacic acid, succinic acid, glutaric acid, decanedicarboxylic acid, maleic acid, fumaric acid, phthalic acid, isophthalic acid, terephthalic acid and the isomeric naphthalenedicarboxylic acids. It is also possible to use the corresponding carboxylic anhydrides, e.g. phthalic anhydride.

The polyesterol is preferably prepared by condensation of
a) at least one polyfunctional alcohol, preferably a diol, having from 2 to 12 carbon atoms, where the diol may optionally additionally have at least one heteroatom, in particular at least one ether function, and
b) at least one polyfunctional carboxylic acid having from 2 to 12 carbon atoms or an anhydride thereof.

The polyesterol is particularly preferably prepared by condensation of
a) at least one polyfunctional alcohol selected from among 1,4-butanediol, 3-methyl-1,5-pentanediol, 1,6-hexanediol, 1,5-pentanediol, diethylene glycol, 1,2-propanediol, 2,2-dimethylpropane-1,3-diol, 2-methylpropane-1,3-diol, trimethylolpropane, glycerol, pentaerythritol, 3-methyl-1,5-pentanediol and ethylene glycol, and
b) at least one polyfunctional carboxylic acid having from 2 to 12 carbon atoms or an anhydride thereof selected from among adipic acid, phthalic anhydride, terephthalic acid, isophthalic acid, sebacic acid, succinic acid and glutaric acid.

It is also possible to use mixtures of at least one polyetherol and/or at least one polyesterol.

The polyesterols have an OH number of from 15 to 500, preferably from 20 to 200.

The silicon dioxide dispersions produced according to the invention and comprising polyols such as polyetherols or polyesterols can be used as polyol component for producing polyurethanes (PUs). The field of use of the silicate-comprising polyols produced according to the invention is very wide. For example, they can be used for producing compact polyurethane, e.g. adhesives, coatings, binders, encapsulation compositions, thermoplastic polyurethanes and elastomers. They can also be used for producing microcellular polyurethane foam, for example for shoe applications, structural foam, integral foam and RIM polyurethanes, for example for bumper bars. Furthermore, they can be used for producing high-density foams, e.g. semi rigid foam and carpet backing foam, low-density foams, e.g. flexible foam, rigid foam, thermoforming foam and packaging foam.

Furthermore, at least one isocyanate-comprising compound is preferably added to the silicon dioxide dispersion of the invention comprising silicon dioxide which has been modified by means of at least one silane (S). The addition of the isocyanate-comprising compound is preferably carried out after the addition of at least one polyol to the silicon dioxide dispersion of the invention. However, the addition of the isocyanate-comprising compound can optionally also be carried out before the addition of polyol. Isocyanate-comprising compounds as such are known to those skilled in the art. Silicon dioxide dispersions comprising i) at least one chain extender, ii) silicon dioxide which has been modified by means of at least one silane (S) and comprises a group which is reactive toward isocyanates, iii) optionally at least one polyol, in particular at least one polyesterol, and iv) at least one isocyanate-comprising compound are thus also provided by the present invention.

Isocyanate-comprising compounds comprise polyisocyanates based on methanedi(phenyl isocyanate) (hereinafter referred to as MDI), dicyclohexylmethane diisocyanate (hereinafter referred to as H12MDI), tolylene diisocyanate, isophorone diisocyanate, naphthalene diisocyanate or hexamethylene diisocyanate. MDI encompasses 2,4-MDI, 4,4′-MDI and homologs having more than two rings and also mixtures thereof. H12MDI encompasses 4,4′-H12MDI, 2,2′-H12MDI and 2,4″-H12MDI and also mixtures thereof.

The polyisocyanate can be used in the form of polyisocyanate prepolymers. These polyisocyanate prepolymers can be obtained by reacting above-described MDI, for example at temperatures of from 30 to 100° C., preferably at about 80° C., with polyetherols or polyesterols or poly-THF (pTHF) or mixtures thereof to form the prepolymer. As polyetherols or polyesterols, preference is given to using the above-described polyetherols or polyesterols. Here, it is possible to use, apart from polyisocyanate prepolymers based on polyethers and polyisocyanate prepolymers based on polyesters, mixtures thereof and polyisocyanate prepolymers based on polyethers and polyesters. The NCO content of the prepolymers is preferably, for example, in the range from 2% to 30%, particularly preferably from 5% to 28% and in particular from 10% to 25%, for MDI-based prepolymers. Suitable polytetrahydrofuran (pTHF) generally has a molecular weight of from 550 to 4000 g/mol, preferably from 750 to 2500 g/mol, particularly preferably from 750 to 1200 g/mol.

The isocyanate-comprising compound is preferably at least one organic polyisocyanate, in particular an organic polyisocyanate selected from among methanedi(phenylisocyanate) (MDI), dicyclohexylmethane diisocyanate (H12MDI), tolylene diisocyanate, isophorone diisocyanate, naphthalene diisocyanate and hexamethylene diisocyanate.

The present invention therefore further provides i) a process for producing the above-described silicon dioxide dispersion of the invention comprising silicon dioxide and chain extender, ii) a process for producing the above-described silicon dioxide dispersion of the invention comprising silicon dioxide which has been modified by means of at least one silane (S) which comprises a group which is reactive toward isocyanates and chain extender, iii) a process for producing the above-described silicon dioxide dispersion of the invention comprising silicon dioxide which has been modified by means of at least one silane (S) which comprises a group which is reactive toward isocyanates, chain extender and at least one polyol, in particular at least one polyesterol, iv) a process for producing the above-described silicon dioxide dispersion of the invention comprising silicon dioxide which has been modified by means of at least one silane (S) which comprises a group which is reactive toward isocyanates, chain extender, optionally at least one polyol, in particular at least one polyesterol, and at least one isocyanate-comprising compound.

The present invention further provides for the use of the respective above-described silicon dioxide dispersion of the invention for producing polyurethane materials or polyurethane elastomers. Particular preference is given to using a silicon dioxide dispersion according to the invention comprising silicon dioxide which has been modified by means of at least one silane (S) comprising a group which is reactive toward isocyanates, chain extender, at least one polyol, in particular at least one polyesterol, and at least one isocyanate-comprising compound.

The present invention further provides a polyurethane elastomer which can be produced by reaction of at least one of the above-described silicon dioxide dispersions (optionally additionally) comprising at least one polyol and at least one isocyanate-comprising compound. The polyurethane elastomer of the invention can preferably be produced using a silicon dioxide dispersion according to the invention comprising i) silicon dioxide which has been modified by means of at least one silane (S) which comprises a group which is reactive toward isocyanates, ii) at least one chain extender, iii) at least one polyol, in particular at least one polyesterol, and iv) at least one isocyanate-comprising compound. The components i) to iv) have been described above.

Processes for producing the polyurethane elastomer of the invention are known in principle to those skilled in the art. In general, polyurethane elastomers or polyurethane materials are produced by reaction of at least one isocyanate-comprising compound and at least one polyol, for example a polyetherol and/or a polyesterol. In addition, further components such as blowing agents or crosslinking agents or crosslinkers can be used in the production of polyurethane elastomers.

Crosslinkers can optionally be used. These are substances having a molecular weight of less than 450 g/mol and 3 hydrogen atoms which are reactive toward isocyanate, for example trials such as 1,2,4-, 1,3,5-trihydroxycyclohexane, glycerol and trimethylol-propane, or low molecular weight hydroxyl-comprising polyalkylene oxides based on ethylene oxide and/or 1,2-propylene oxide and the abovementioned trials as starter molecules.

Blowing agents and/or water are optionally present in the production of polyurethane elastomers, in particular polyurethane foams. As blowing agents, it is possible to use water and also generally known chemical and/or physical blowing agents. For the purposes of the present invention, chemical blowing agents are compounds which react with isocyanate to form gaseous products, for example water or formic acid. Physical blowing agents are compounds which are dissolved or emulsified in the starting materials for polyurethane production and vaporize under the conditions of polyurethane formation. These are, for example, hydrocarbons, halogenated hydrocarbons and other compounds, for example perfluorinated alkanes such as perfluorohexane, chlorofluorocarbons and ethers, esters, ketones, acetals and also inorganic and organic compounds which liberate nitrogen on heating or mixtures thereof, for example (cyclo)aliphatic hydrocarbons having from 4 to 8 carbon atoms or fluorinated hydrocarbons such as Solkane® 365 mfc from Solvay Fluorides LLC. It is also possible to use solid components as blowing agents. These are, for example, expandable microspheres such as Expansel® from AKZO, or chemical blowing agents such as citric acid, hydrogencarbonates or azocarboxamides.

In addition, catalysts can be used for producing the polyurethane elastomer of the invention. As catalysts, preference is given to using compounds which greatly accelerate the reaction of the polyol with the isocyanate-comprising compound. Mention may be made by way of example of amidines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, bis(dimethylaminoethyl) ether, urea, bis(dimethylaminopropyl)urea, dimethylpiperazine, 1,2-dimethylimidazole, 1-azabicyclo[3.3.0]octane and preferably 1,4-diazabicyclo[2.2.2]octane and alkanolamine compounds such as triethanolamine, triisopropanolamine, N-methyldiethanolamine and N-ethyldiethanolamine and dimethylethanolamine, N,N-dimethylethanolamine, N,N-dimethylcyclohexylamine, bis(N,N-dimethylaminoethyl) ether, N,N,N′,N′,N″-pentamethyldiethylenetriamine, 1,4-diazabicyclo[2.2.2]octane, 2-(2-dimethylaminoethoxy)ethanol, 2-((2-dimethylaminoethoxy)ethylmethylamino)-ethanol, 1-(bis(3-dimethylamino)propyl)amino-2-propanol, N,N′,N″tris(3-dimethylaminopropyl)hexahydrotriazines, bis(morpholinoethyl) ether, N,N-dimethylbenzylamine, N,N,N′,N″,N″-pentamethyldipropylenetriamine or N,N′-diethylpiperazine. It is also possible to use alkylene polyamines such as triethylenediamine. Further possible catalysts are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate, dibutyltin mercaptide and dioctyltin diacetate, and also bismuth carboxylates, such as bismuth(III) neodecanoate, bismuth 2-ethylhexanoate and bismuth octanoate or mixtures thereof, titanium(IV) chelates, phenylmercury propionate, lead octoate, potassium acetate/octoate, quatemary ammonium formates and iron acetylacetonate. The organic metal compounds can be used either alone or preferably in combination with strongly basic amines. Furthermore, the abovementioned catalysts can initially be incorporated in chain extenders such as 1,4-butanediol or polyalkylene glycols such as dipropylene glycol and diethylene glycol.

Preference is given to using from 0.001 to 5% by weight, in particular from 0.05 to 2% by weight, of catalyst or catalyst combination, based on the weight of polyol, chain extender, silicon dioxide and isocyanate-comprising compound.

Auxiliaries and/or additives can optionally also be added to the reaction mixture for producing the polyurethane elastomers. Mention may be made by way of example of surface-active substances, stabilizers such as foam stabilizers or hydrolysis stabilizers, cell regulators, further mold release agents, fillers, dyes, pigments, hydrolysis inhibitors, odor-absorbing substances and fungistatic and/or bacteriostatic substances.

Possible surface-active substances are, for example, compounds which serve to aid homogenization of the starting materials and may also be suitable for regulating the cell structure. Mention may be made by way of example of emulsifiers such as the sodium salts of castor oil sulfates or of fatty acids and also salts of fatty acids with amines, e.g. diethylamine oleate, diethanolamine stearate, diethanolamine ricinoleate, salts of sulfonic acids, e.g. alkali metal or ammonium salts of dodecylbenzenesulfonic or dinaphthylmethanedisulfonic acid, and nicinoleic acid; foam stabilizers such as siloxane-oxyalkylene copolymers and other organopolysiloxanes, ethoxylated alkyiphenols, ethoxylated fatty alcohols, paraffin oils, castor oil or ricinoleic esters, Turkey red oil and peanut oil, and cell regulators such as paraffins, fatty alcohols and dimethylpolysiloxanes. Oligomeric acrylates having polyoxyalkylene and fluoroalkane radicals as side groups are also suitable for improving the emulsifying action, the cell structure and/or stabilizing the foam. The surface-active substances are usually added in amounts of from 0.01 to 5 parts by weight based on the weight of polyol, chain extender, silicon dioxide and isocyanate-comprising compound.

The polyurethane elastomers of the invention can be produced by the one-shot or prepolymer process with the aid of the low-pressure or high-pressure technique. The foams can be produced as slabstock foam or as molded foam. Elastomers can be produced in a casting process. TPUs can be produced in a batch process, belt process or a reactive extrusion process. These processes are described, for example, in The Polyurethanes Book” Randall and Lee, Eds, Wiley, 2002.

The polyurethane elastomers of the invention are preferably thermoplastic polyurethane (TPU). TPUs as such are known to those skilled in the art. TPUs are disclosed, for example, in the European patent application PCT/EP2010/058763. Thus, the TPUs of the invention can also be additionally crosslinked by reaction with a further isocyanate-comprising compound in a second reaction stage (further PU reaction stage).

Articles made of TPUs are preferably produced by melting the polyurethane (which is used as starting material) and processing it in an extruder or in an injection molding process.

In a preferred embodiment of the present invention, the polyurethane elastomer is produced by reaction of a silicon dioxide dispersion which can be produced by a process comprising the following steps:

a) admixing of an aqueous silica sol (K) having an average particle diameter of from 1 to 150 nm, a content of silicon dioxide of from 1 to 60% by weight and a pH of from 1 to 6 with at least one chain extender to give a mixture (A) of aqueous silica sol and chain extender,
b) removal of the water from the mixture (A) obtained in step (a).

The silicon dioxide comprised in the silicon dioxide dispersion is modified by means of at least one silane (S) which comprises a group which is reactive toward isocyanates. The silane (S) preferably has an at least monoalkoxylated silyl group, a hydroxyl-comprising substituent, an amino-comprising substituent and/or an alkyl, cycloalkyl or aryl substituent.

The silicon dioxide dispersion further comprises at least one polyesterol and at least one isocyanate-comprising compound. The polyesterol is preferably produced by condensation of
a) at least one polyfunctional alcohol, preferably a diol, having from 2 to 12 carbon atoms, where the diol may optionally additionally have at least one heteroatom, in particular at least one ether function, and
b) at least one polyfunctional carboxylic acid having from 2 to 12 carbon atoms or an anhydride thereof.

The isocyanate-comprising compound is selected from among methanedi(phenyl isocyanate) (MDI), dicyclohexylmethane diisocyanate (H12MDI), tolylene diisocyanate, isophorone diisocyanate, naphthalene diisocyanate and hexamethylene diisocyanate.

In a further preferred embodiment of the present invention, the polyurethane elastomer is produced by reaction of a silicon dioxide dispersion which can be produced by a process comprising the following steps:
a) admixing of an aqueous silica sol (K) having an average particle diameter of from 1 to 150 nm, a content of silicon dioxide of from 1 to 60% by weight and a pH of from 1 to 6 with at least one chain extender to give a mixture (A) of aqueous silica sol and chain extender,
b) removal of the water from the mixture (A) obtained in step (a).

The silicon dioxide comprised in the silicon dioxide dispersion is modified by means of at least one silane (S) which comprises a group which is reactive toward isocyanates and which is produced by reacting i) a trialkoxysilane substituted by an epoxyalkyl group and ii) a polyetheramine. Most preferably, the compound i) is 3-glycidoxypropyltrimethoxysilane and the compound ii) is a monofunctional polyetheramine having a molecular eight of 500 to 2500.

The silicon dioxide dispersion further comprises at least one polyesterol and at least one isocyanate-comprising compound. The polyesterol is preferably produced by condensation of
a) at least one polyfunctional alcohol, preferably a diol, having from 2 to 12 carbon atoms, where the diol may optionally additionally have at least one heteroatom, in particular at least one ether function, and
b) at least one polyfunctional carboxylic acid having from 2 to 12 carbon atoms or an anhydride thereof.

The isocyanate-comprising compound is selected from among methanedi(phenyl isocyanate) (MDI), dicyclohexylmethane diisocyanate (H12MDI), tolylene diisocyanate, isophorone diisocyanate, naphthalene diisocyanate and hexamethylene diisocyanate.

The present invention further provides for the use of one of the above-described polyurethane elastomers for producing moldings in a casting, injection molding, calendering, powder sintering or extrusion process. The moldings are preferably rollers, shoe soles, linings in automobiles, sieves, wheels, tires, conveyor belts, components for engineering, hoses, coatings, cables, profiles, laminates, plug connections, cable plugs, bellows, towing cables, wipers, sealing lips, cable sheathing, seals, belts, damping elements, films or fibers. Further examples of uses of elastomers are described, for example, in “The Polyurethanes Book”, Randall and Lee, Eds., Wiley 2002.

The present invention further provides a polymer blend or a mixture comprising at least one of the above-described thermoplastic polyurethanes and additionally at least one other polymer. Other polymer means that this polymer does not come under the definitions of the thermoplastic polyurethanes of the invention. The other polymer is preferably a thermoplastic polyurethane, a polyester, polyether or a polyamide. In particular, the other polymer is present in a total amount of from 5 to 40%, based on the thermoplastic polyurethane of the invention.

The present invention further provides films, injection molded articles or extruded articles comprising at least one thermoplastic polyurethane according to the invention.

The invention is illustrated below by the examples.

### EXAMPLES

TABLE 1

| Abbreviation | Composition |
|---|---|
| ISO-1 | Lupranat ® ME; 4,4′-MDI; BASF SE; |
| | Ludwigshafen; Germany |
| ISO-2 | Lupranat ® MP102; prepolymer derived from 4,4′-MDI |
| | and a glycol mixture; NCO content = 22.9%; BASF |
| | SE; Ludwigshafen; Germany |
| ISO-3 | Lupranat ® MM103; 4,4′-MDI, carbodiimide-modified; |
| | NCO content = 29.5%; BASF SE; Ludwigshafen; Germany |
| Polyesterol 1 | Polyester diol (butanediol-adipic acid) having a number |
| | average molecular weight (Mn) of 1000 g/mol |
| Polyesterol 2 | Polyester diol (ethylene glycol-butanediol- |
| | adipic acid) having a number average molecular |
| | weight (Mn) of 2000 g/mol |
| Catalyst 1 | Titanium(IV) chelate catalyst in 1,4-butanediol |
| Catalyst 2 | Zinc neodecanoate and bismuth neodecanoate in |
| | polypropylene glycol (2000 g/mol) |
| Catalyst 3 | Triethylenediamine in dipropylene glycol |
| Stabilizer 1 | Mixture of polyethersiloxane and silicone oil |

### A Transfer of Unmodified Silicon Dioxide Nanoparticles into Chain Extenders and Production of Stable Silicon Dioxide Dispersions

### Example A1

233 g of 1,4-butanediol are added to 500 g of a commercially available acidic silica sol (Levasil® 200E/20% from H.C. Starck GmbH & Co KG, Leverkusen, Germany, particle diameter based on the BET method: 15 nm, pH 2.5, silicon dioxide concentration: 20% by weight). The water is removed under reduced pressure at a temperature which is increased stepwise from 30° C. to 75° C. over a period of 6 hours, with the temperature being 75° C. for the last 1-2 hours. A stable, transparent silicon dioxide dispersion in 1,4-butanediol having a silicon dioxide concentration of 30% by weight is obtained.

### Example A2

150 g of monoethylene glycol are added to 500 g of a commercially available acidic silica sol (Levasil® E/20% from H.C. Starck GmbH & Co KG, Leverkusen, Germany, particle diameter based on the BET method: 15 nm, pH 2.5, silicon dioxide concentration: 20% by weight). The water is removed under reduced pressure at a temperature which is increased stepwise from 30° C. to 75° C. over a period of 6 hours, with the temperature being 75° C. for the last 1-2 hours. A stable, transparent silicon dioxide dispersion in monoethylene glycol having a silicon dioxide concentration of 40% by weight is obtained.

### B Surface Modification of Silicon Dioxide Nanoparticles in Chain Extenders

The silicon dioxide concentration of the dispersion after surface modification is based on pure silicon dioxide.

### Example B1

In a 1 l glass flask provided with a stirrer, 333 g of the silicon dioxide dispersion in 1,4-butanediol from example A1 having a silicon dioxide concentration of 30% by weight and 58.8 g (0.27 mol) of 3-aminopropyltriethoxysilane (from Merck Schuchardt OHG, Hohenbrunn, Germany) are mixed. The mixture obtained is stirred at 70° C. for 24 hours. Volatile constituents are distilled off at 75° C. under reduced pressure over a period of 2 hours. A stable, transparent silicon dioxide dispersion in 1,4-butanediol having a silicon dioxide concentration of 28.1% by weight is obtained.

Theoretical OH number of the dispersion: 817.2 mg KOH/g, measured: 810 mg KOH/g

Theoretical amine number of the dispersion: 41.9 mg KOH/g, measured: 40 mg KOH/g

The theoretical values of the dispersions are used for all further calculations.

The mixture obtained will hereinafter be referred to as dispersion 1.

### Example B2

In a 1 l glass flask provided with a stirrer, 333 g of the silicon dioxide dispersion in 1,4-butanediol from example A1 having a silicon dioxide concentration of 30% by weight and 29.4 g (0.13 mol) of 3-aminopropyltriethoxysilane (from Merck Schuchardt OHG, Hohenbrunn, Germany) are mixed. The mixture obtained is stirred at 70° C. for 24 hours. Volatile constituents are distilled off at 75° C. under reduced pressure over a period of 2 hours. A stable, transparent silicon dioxide dispersion in 1,4-butanediol having a silicon dioxide concentration of 29.0% by weight is obtained.

The mixture obtained will hereinafter be referred to as dispersion 2.

### Example B3

In a 1 l glass flask provided with a stirrer, 250 g of the silicon dioxide dispersion in monoethylene glycol from example A2 having a silicon dioxide concentration of 40% by weight, 83 g of monoethylene glycol and 29.4 g (0.13 mol) of 3-aminopropyltriethoxysilane (from Merck Schuchardt OHG, Hohenbrunn, Germany) are mixed. The mixture obtained is stirred at 70° C. for 24 hours. Volatile constituents are distilled off at 75° C. under reduced pressure over a period of 2 hours. A stable, transparent silicon dioxide dispersion in monoethylene glycol having a silicon dioxide concentration of 29.0% by weight is obtained.

### Example B4

In a 1 l glass flask provided with a stirrer, 333,33 g of the silicon dioxide dispersion in 1,4-butanediol from example A1 having a silicon dioxide concentration of 30% by weight, 166,67 g 1,4-butandiole and 74,27 g (33,2 mmol) of the product obtained by reaction of 23,63 g 3-glycidoxypropyitrimethoxysilane (from Sigma-Aldrich Chemie GmbH, Steinheim, Germany) with 200 g Jeffamine® M-2070 (from Huntsman Performance Chemicals, Everberg, Belgium) (the mixture of both components is stirred for 12 h at 50° C.) are mixed. The mixture obtained is stirred at 70° C. for 24 hours. Volatile constituents are distilled off at 75° C. under reduced pressure over a period of 2 hours. A stable, transparent silicon dioxide dispersion in 1,4-butanediol having a silicon dioxide concentration of 18.8% by weight is obtained.

The mixture obtained will hereinafter be referred to as dispersion 4.

### C Comparative Examples

### Example C1

100 g of a commercially available acidic silica sol (Levasil® 200E/20% from H.C. Starck GmbH & Co KG, Leverkusen, Germany, particle diameter based on the BET method: 15 nm, pH 2.5, silicon dioxide concentration: 20% by weight) are mixed with 100 g in each case of polyesterol 1 and 2 at room temperature and 60° C. A gel-like product is immediately obtained every time.

### Example C2

100 g of a commercially available acidic silica sol (Levasil® 200E/20% from H.C. Starck GmbH & Co KG, Leverkusen, Germany, particle diameter based on the BET method: 15 nm, pH 2.5, silicon dioxide concentration: 20% by weight) are mixed with 100 g of isopropanol at 60° C. This gives a clear, stable silicon dioxide dispersion. 50 g in each case of polyesterol 1 and 2 are mixed at 60° C. with 50 g in each case of isopropanol. All solutions obtained are clear and stable. On mixing the pure silica sol or the silicon dioxide dispersion comprising 50% of isopropanol with a pure polyesterol 1 or 2 or with one of the solutions composed of polyesterol and isopropanol at 60° C. or room temperature, a turbid and gel-like product is immediately obtained in all cases.

### Example C3

In a 1 l glass flask provided with a stirrer, 333 g of the silicon dioxide dispersion in 1,4-butanediol from example A1 having a silicon dioxide concentration of 30% by weight, 7.2 g (0.40 mol) of water and 29.4 g (0.13 mol) of 3-aminopropyltriethoxysilane (from Merck Schuchardt OHG, Hohenbrunn, Germany) are mixed. The mixture obtained is stirred at 70° C. After a short time, a turbid product is obtained and this becomes gel-like during distillation.

It can be seen from examples C1 and C2 that aqueous silica sols cannot be introduced directly or with the aid of organic solvents into polyols, in particular into polyesterols. Example C3 shows that silanization by means of 3-aminopropyltriethoxysilane is possible only in a largely water-free medium.

### D Polyurethane Production

### Example D1

### Comparison

In a 2 l tinned plate bucket, 940.0 g of polyesterol 1 and 83.68 g of 1,4-butanediol are heated to 90° C. 7.52 g of hydrolysis stabilizer (carbodiimide) are subsequently added while stirring. After the solution has subsequently been heated to 80° C., 470.0 g of ISO-1 are added and the mixture is stirred until the temperature is 110° C. The reaction mixture is subsequently poured into a flat dish and heated at 125° C. on a hotplate for 10 minutes. The resulting sheet is then heated at 80° C. in an oven for 15 hours. The sheet is comminuted in a mill and the material is subsequently processed to give injection molded plates (dimensions of the injection molded plates 110 mm×25 mm×2 mm). The test plates are heated at 100° C. for 20 hours and their mechanical properties are determined.

### Example D2

In a 2 l tinned plate bucket, 940.0 g of polyesterol 1, 74.65 g of 1,4-butanediol and 13.01 g of dispersion 2 (0.25% of SiO₂ based on the total mass) are heated to 90° C. 7.52 g of hydrolysis stabilizer (carbodiimide) are subsequently added while stirring. After the solution has subsequently been heated to 80° C., 470.0 g of ISO-1 are added and the mixture is stirred until the temperature is 110° C. The reaction mixture is subsequently poured into a flat dish and heated at 125° C. on a hotplate for 10 minutes. The resulting sheet is then heated at 80° C. in an oven for 15 hours. The sheet is comminuted in a mill and the material is subsequently processed to give injection molded plates (dimensions of the injection molded plates 110 mm×25 mm×2 mm). The test plates are heated at 100° C. for 20 hours and their mechanical properties are determined.

### Example D3

In a 2 l tinned plate bucket, 940.0 g of polyesterol 1, 74.39 g of 1,4-butanediol and 13.46 g of dispersion 1 (0.25% of SiO₂ based on the total mass) are heated to 90° C. 7.52 g of hydrolysis stabilizer (carbodiimide) are subsequently added while stirring. After the solution has subsequently been heated to 80° C., 470.0 g of ISO-1 are added and the mixture is stirred until the temperature is 110° C. The reaction mixture is subsequently poured into a flat dish and heated at 125° C. on a hotplate for 10 minutes. The resulting sheet is then heated at 80° C. in an oven for 15 hours. The sheet is comminuted in a mill and the material is subsequently processed to give injection molded plates (dimensions of the injection molded plates 110 mm×25 mm×2 mm). The test plates are heated at 100° C. for 20 hours and their mechanical properties are determined.

### Example D4

In a 2 l tinned plate bucket, 940.0 g of polyesterol 1, 47.28 g of 1,4-butanediol and 52.39 g of dispersion 2 (1% of SiO₂ based on the total mass) are heated to 90° C. 7.52 g of hydrolysis stabilizer (carbodiimide) are subsequently added while stirring. After the solution has subsequently been heated to 80° C., 470.0 g of ISO-1 are added and the mixture is stirred until the temperature is 110° C. The reaction mixture is subsequently poured into a flat dish and heated at 125° C. on a hotplate for 10 minutes. The resulting sheet is then heated at 80° C. in an oven for 15 hours. The sheet is comminuted in a mill and the material is subsequently processed to give injection molded plates (dimensions of the injection molded plates 110 mm×25 mm×2 mm). The test plates are heated at 100° C. for 20 hours and their mechanical properties are determined.

### Example D5

In a 2 l tinned plate bucket, 940.0 g of polyesterol 1, 46.03 g of 1,4-butanediol and 54.58 g of dispersion 1 (1% of SiO₂ based on the total mass) are heated to 90° C. 7.52 g of hydrolysis stabilizer (carbodiimide) are subsequently added while stirring. After the solution has subsequently been heated to 80° C., 470.0 g of ISO-1 are added and the mixture is stirred until the temperature is 110° C. The reaction mixture is subsequently poured into a flat dish and heated at 125° C. on a hotplate for 10 minutes. The resulting sheet is then heated at 80° C. in an oven for 15 hours. The sheet is comminuted in a mill and the material is subsequently processed to give injection molded plates (dimensions of the injection molded plates 110 mm×25 mm×2 mm). The test plates can still be processed, but are slightly turbid. This shows that the maximum useable proportion of modified silicon dioxide nanoparticles has been reached. The test plates are heated at 100° C. for 20 hours and their mechanical properties are determined.

The properties which can be seen from table 2 are determined:

TABLE 2

| | | | Example D1 | Example | Example | Example | Example |
|---|---|---|---|---|---|---|---|
| Property | Unit | Test method | (comparison) | D2 | D3 | D4 | D5 |
| Density | g/cm³ | DIN EN ISO 1183-1, A | 1.202 | 1.206 | 1.204 | 1.208 | 1.207 |
| Shore hardness A | — | DIN 53 505 | 85 | 83 | 83 | 84 | 82 |
| Abrasion | mm³ | DIN ISO 4649 | 31 | 38 | 27 | 33 | 38 |
| Vicat softening temperature | ° C. | DIN EN ISO 306 | 106.5 | 114.2 | 118.4 | 117.4 | 125.1 |
| (method A 120: 10N; 120° C./h) | | | | | | | |
| CS 72 h/23° C./30 min | % | DIN ISO 815 | 25 | 20 | 22 | 21 | 21 |
| CS 24 h/70° C./30 min | % | DIN ISO 815 | 42 | 34 | 32 | 29 | 29 |
| CS 24 h/100° C./30 min | % | DIN ISO 815 | 59 | 50 | 43 | 49 | 45 |
| TMA | ° C. | ISO 11359-3 | 144 | 175 | 195 | 196 | 211 |

The results of the examples according to the invention show a significant increase in the Vicat softening temperature and the maximum temperature of the thermomechanical analysis (TMA) and a significant decrease in the compression set.

### Example D6

### Comparison

106.8 g of polyesterol 2; 4,0 g of K-Ca-Na zeolite A (50% in castor oil); 0.91 g of stabilizer 1; 0.17 g of catalyst 1; 0.06 g of catalyst 2; 0.03 g of catalyst 3 and 13.8 g of 1,4-butanediol were heated to 40° C. and homogenized in a Speedmixer. The component was admixed with a mixture of 63.1 g of ISO-2 and 11.1 g of ISO-3 which had been heated to 40° C. and mixed by means of the Speedmixer for 1 minute. The reaction mixture obtained in this way was poured into an unheated open mold having dimensions of 300 mm×200 mm×2 mm and allowed to react fully overnight. The procedure was repeated twice in order to fill two further molds having dimensions of 200 mm×150 mm×4 mm and 200 mm×150 mm×6 mm. On the next day, the three plates were removed from the molds and heated at 80° C. for 2 hours. Suitable test specimens were stamped from the plates in order to determine their mechanical properties.

### Example D7

106.8 g of polyesterol 2; 4.0 g of K-Ca-Na zeolite A (50% in castor oil); 0.91 g of stabilizer 1; 0.17 g of catalyst 1; 0.06 g of catalyst 2; 0.03 g of catalyst 3; 12.7 g of 1,4-butanediol and 1.7 g of dispersion 1 were heated to 40° C. and homogenized in a Speedmixer. The component was admixed with a mixture of 63.1 g of ISO-2 and 11.1 g of ISO-3 which had been heated to 40° C. and mixed by means of the Speedmixer for 1 minute. The reaction mixture obtained in this way was poured into an unheated open mold having dimensions of 300 mm×200 mm×2 mm and allowed to react fully overnight. The procedure was repeated twice in order to fill two further molds having dimensions of 200 mm×150 mm×4 mm and 200 mm×150 mm×6 mm. On the next day, the three plates were removed from the molds and heated at 80° C. for 2 hours. Suitable test specimens were stamped from the plates in order to determine their mechanical properties.

### Example D8

106.8 g of polyesterol 2; 4.0 g of K-Ca-Na zeolite A (50% in castor oil); 0.91 g of stabilizer 1; 0.17 g of catalyst 1; 0.06 g of catalyst 2; 0.03 g of catalyst 3; 9.2 g of 1,4-butanediol and 6.7 g of dispersion 1 were heated to 40° C. and homogenized in a Speedmixer. The component was admixed with a mixture of 63.1 g of ISO-2 and 11.1 g of ISO-3 which had been heated to 40° C. and mixed by means of the Speedmixer for 1 minute. The reaction mixture obtained in this way was poured into an unheated open mold having dimensions of 300 mm×200 mm×2 mm and allowed to react fully overnight. The procedure was repeated twice in order to fill two further molds having dimensions of 200 mm×150 mm×4 mm and 200 mm×150 mm×6 mm. On the next day, the three plates were removed from the molds and heated at 80° C. for 2 hours. Suitable test specimens were stamped from the plates in order to determine their mechanical properties.

### Example D9

106.8 g of polyesterol 2; 4.0 g of K-Ca-Na zeolite A (50% in castor oil); 0.91 g of stabilizer 1; 0.17 g of catalyst 1; 0.06 g of catalyst 2; 0.03 g of catalyst 3; 11.9 g of 1,4-butanediol and 2.5 g of dispersion 3 were heated to 40° C. and homogenized in a Speedmixer. The component was admixed with a mixture of 63.1 g of ISO-2 and 11.1 g of ISO-3 which had been heated to 40° C. and mixed by means of the Speedmixer for 1 minute. The reaction mixture obtained in this way was poured into an unheated open mold having dimensions of 300 mm×200 mm×2 mm and allowed to react fully overnight. The procedure was repeated twice in order to fill two further molds having dimensions of 200 mm×150 mm×4 mm and 200 mm×150 mm×6 mm. On the next day, the three plates were removed from the molds and heated at 80° C. for 2 hours. Suitable test specimens were stamped from the plates in order to determine their mechanical properties.

The properties which can be seen from table 3 are determined:

TABLE 3

| | | | Example | | | |
|---|---|---|---|---|---|---|
| | | | D6 | Example | Example | Example |
| Property | Unit | Test method | (comparison) | D7 | D8 | D9 |
| Density | g/cm³ | DIN EN ISO 1183-1, A | 1.220 | 1.219 | 1.220 | 1.222 |
| Shore hardness A | — | DIN 53 505 | 87 | 87 | 88 | 90 |
| Tensile strength | MPa | DIN EN ISO 527 | 10 | 12 | 12 | 40 |
| Elongation at | % | DIN EN ISO 527 | 400 | 410 | 370 | 500 |
| break | | | | | | |
| Stress at 100% | MPa | DIN EN ISO 527 | 5.5 | 6.2 | 6.2 | not |
| elongation | | | | | | measured |
| Stress at 200% | MPa | DIN EN ISO 527 | 6.9 | 7.9 | 8.1 | not |
| elongation | | | | | | measured |
| Stress at 300% | MPa | DIN EN ISO 527 | 8.5 | 9.7 | 10.2 | not |
| elongation | | | | | | measured |
| Tear | kN/m | DIN ISO 34-1, B (b) | 40 | 43 | 43 | 51 |
| propagation | | | | | | |
| resistance | | | | | | |
| Abrasion | mm³ | DIN ISO 4649 | 110 | 94 | 73 | 65 |
| Vicat softening | ° C. | DIN EN ISO 306 | 73.2 | 91.3 | 87.1 | 107.7 |
| temperature | | | | | | |
| (Method A 120: | | | | | | |
| 10N; 120° C/h) | | | | | | |
| CS 72 h/23° C./30 min | % | DIN ISO 815 | 30 | 20 | 24 | 24 |
| CS 24 h/70° C./30 min | % | DIN ISO 815 | 65 | 50 | 55 | 55 |

The results of the examples according to the invention show a significant increase in the Vicat softening temperature, the stress values at various elongations and a significant decrease in the compression set and the abrasion.

1. A silicon dioxide dispersion which can be produced by a process comprising the following steps:
a) admixing of an aqueous silica sol (K) having an average particle diameter of from 1 to 150 nm, a content of silicon dioxide of from 1 to 60% by weight and a pH of from 1 to 6 with at least one chain extender to give a mixture (A) of aqueous silica sol and chain extender,
b) removal of the water from the mixture (A) obtained in step (a).

2. The silicon dioxide dispersion according to claim 1, wherein, in step (b), the water is removed completely or to a residual amount of less than 0.5% by weight (based on the silicon dioxide dispersion) or the water is removed at a temperature which is increased stepwise in the range from 30° C. to 75° C.

3. The silicon dioxide dispersion according to claim 1, wherein the chain extender is selected from a diol having a molecular weight of less than 300 g/mol.

4. The silicon dioxide dispersion according to claim 3, wherein the chain extender is selected from among 1,4-butanediol and monoethylene glycol.

5. The silicon dioxide dispersion according to claim 1, wherein the silicon dioxide comprised in the silicon dioxide dispersion is modified by means of at least one silane (S) which comprises a group which is reactive toward isocyanates.

6. The silicon dioxide dispersion according to claim 5, wherein the silane (S) has an at least monoalkoxylated silyl group, a hydroxyl-comprising substituent, an amino-comprising substituent or an alkyl, cycloalkyl or aryl substituent.

7. The silicon dioxide dispersion according to claim 5, wherein a silane (S) is employed, which is produced by reacting i) a trialkoxysilane substituted by an epoxyalkyl group and ii) a polyetheramine.

8. The silicon dioxide dispersion according to claim 7, wherein the compound i) is 3-glycidoxypropyltrimethoxysilane and the compound ii) is a monofunctional polyetheramine having a molecular weight of 500 to 2500.

9. The silicon dioxide dispersion according to claim 5, wherein at least one polyol is added to the silicon dioxide dispersion comprising silicon dioxide which has been modified by means of at least one silane (S).

10. The silicon dioxide dispersion according to claim 9, wherein the polyol is a polyesterol.

11. The silicon dioxide dispersion according to claim 10, wherein the polyesterol is prepared by condensation of
a) at least one polyfunctional alcohol and
b) at least one polyfunctional carboxylic acid having from 2 to 12 carbon atoms or an anhydride thereof.

12. The silicon dioxide dispersion according to claim 11, wherein the polyfunctional alcohol is a diol, having from 2 to 12 carbon atoms, where the diol may optionally additionally have at least one heteroatom.

13. The silicon dioxide dispersion according to any of claim 5, wherein at least one isocyanate-comprising compound is added to the silicon dioxide dispersion comprising silicon dioxide which has been modified by means of at least one silane (S).

14. The silicon dioxide dispersion according to claim 13, wherein the isocyanate-comprising compound is an organic polyisocyanate selected from among methanedi(phenyl isocyanate) (MDI), dicyclohexylmethane diisocyanate (H12MDI), tolylene diisocyanate, isophorone diisocyanate, naphthalene diisocyanate and hexamethylene diisocyanate.

15. A polyurethane elastomer which can be produced by reaction of at least one silicon dioxide dispersion according to claim 1, which additionally comprises at least one polyol and at least one isocyanate-comprising compound.

16. The polyurethane elastomer according to claim 15, wherein the silicon dioxide comprised in the silicon dioxide dispersion is modified by means of at least one silane (S) which comprises a group which is reactive toward isocyanates.

17. The polyurethane elastomer according to claim 14, wherein the elastomer is a thermoplastic polyurethane (TPU).

18. The polyurethane elastomer according to claim 17, wherein the polyurethane is melted and processed in an extruder or in an injection molding process.

19. The polyurethane elastomer according to claim 15, wherein a silicon dioxide dispersion comprising at least one polyesterol and an isocyanate-comprising compound selected from among methanedi(phenyl isocyanate) (MDI), dicyclohexylmethane diisocyanate (H12MDI), tolylene diisocyanate, isophorone diisocyanate, naphthalene diisocyanate and hexamethylene diisocyanate are reacted, and
the silicon dioxide comprised in the silicon dioxide dispersion is modified by means of at least one silane (S) which comprises a group which is reactive toward isocyanates, and
the polyesterol is prepared by condensation of
a) at least one polyfunctional alcohol and
b) at least one polyfunctional carboxylic acid having from 2 to 12 carbon atoms or an anhydride thereof.

20. The polyurethane elastomer according to claim 15, wherein a silicon dioxide dispersion comprising at least one polyesterol and an isocyanate-comprising compound selected from among methanedi(phenyl isocyanate) (MDI), dicyclohexylmethane diisocyanate (H12MDI), tolylene diisocyanate, isophorone diisocyanate, naphthalene diisocyanate and hexamethylene diisocyanate are reacted, and
the silicon dioxide comprised in the silicon dioxide dispersion is modified by means of at least one silane (S) which comprises a group which is reactive toward isocyanates, and said silane (S) is produced by reacting i) a trialkoxysilane substituted by an epoxyalkyl group and ii) a polyetheramine, and the polyesterol is prepared by condensation of
a) at least one polyfunctional alcohol and
b) at least one polyfunctional carboxylic acid having from 2 to 12 carbon atoms or an anhydride thereof.

21. The polyurethane elastomer according to claim 15 to be employed for producing moldings, rollers, shoe soles, linings in automobiles, sieves, wheels, tires, conveyor belts, components for engineering, hoses, coatings, cables, profiles, laminates, plug connections, cable plugs, bellows, towing cables, wipers, sealing lips, cable sheathing, seals, belts, damping elements, films or fibers, in a casting, injection molding, calendering, powder sintering or extrusion process.

22. A polymer blend or mixture comprising at least one thermoplastic polyurethane according to claim 15 and additionally at least one other polymer.

23. The polymer blend according to claim 22, wherein the other polymer is selected from a (different) thermoplastic polyurethane, a polyester, polyether or a polyamide.

24. A film, injection molded article or extruded article comprising at least one thermoplastic polyurethane according to claim 15.
